(19) United States
(12) Patent Application Publication
(10) Pub. No.: US 2006/0063532 A1
(43) Pub. Date: Mar. 23, 2006

(54) Method and device for controlling and determining communication transmission route

(76) Inventors: Kae-Jy Chou, Hsinchu Hsien (TW); Junfeng Lu, Shang-Hai City (CN); Dandan Qiu, Shang-Hai City (CN); Chee-Kong Chong, Taipei Hsien (TW)

Correspondence Address: SUPREME PATENT SERVICES, P.O. BOX 2339, SARATOGA, CA, 95070-0339, US

(21) Appl. No.: 10/947,674

(22) Filed: Sep. 22, 2004

(51) Int. Cl. H04Q 7/20

(52) U.S. Cl. 455/445; 370/351

(57) ABSTRACT

A method and device for controlling and determining communication transmission route is disclosed, which is used to determine the transmission route among a group of Bluetooth phone bases, and the control message is transmitted through the transmission route in succession so as to establish a communication network. A control and manipulation device includes a navigation map module and a route determination module. The navigation map module receives the registration procedure carried out by the group of Bluetooth phone bases through Bluetooth wireless broadcast, and obtaining through which the relative position information of the group of Bluetooth phone bases in the communication network, so as to establish a navigation map. The route determination module determines the transmission route based on the navigation map and through a route determination procedure, such that the control message is transmitted from the respective phone base to the control and manipulation device via the other phone bases.

### BACKGROUND OF THE INVENTION

1. Field of the Invention

The present invention relates to the field of wireless communication, and in particular to a method and device for controlling and determining communication transmission route among Bluetooth phone bases.

2. The Prior Arts

Roaming between different phone bases requires switching of communication transmission route between the phone bases. This is generally done under the control of a route control and manipulation device 1. FIG. 1 of the attached drawings shows a conventional architecture of a Bluetooth communication network, which is disclosed in Taiwan Patent Application No. 93106503. In the conventional system shown in FIG. 1, there are shown, for illustration purposes, six Bluetooth phone bases 10, 20, 30, 40, 50, 60, each having a coverage area indicated by a phantom line circle, designated with reference numeral 12, 22, 32, 42, 52, 62, respectively. A Bluetooth communication device, designated 14, 24, 34, 44, 54, 64, is located respectively in the coverage areas 12, 22, 32, 42, 52, 62 of the associated Bluetooth phone bases 10, 20, 30, 40, 50, 60.

For purposes of illustration and simplification, the Bluetooth phone base 20 and the Bluetooth communication device 24 are taken as an example to explain the operation of route determination and control employed in the prior art. The Bluetooth phone base 20 is connected to a Private Automatic Branch Exchange (PABX) station 3. An incoming call forwarded from the PABX station 3 to the Bluetooth phone base 20 actuates the PABX station 3 to alert the Bluetooth communication device 24 that is located within its coverage area 22 by means of Bluetooth communication. Once a Bluetooth communication subscriber answers the call with the Bluetooth communication device 24, the PABX station 3 establishes a communication connection between the calling party and the called party.

When the Bluetooth communication device 24 moves outside the coverage area 22 of the original phone base 20 and gets into, for example, the coverage area 42 of a neighboring Bluetooth phone base 40, the Bluetooth phone base 40 initiates transmission of a control message of registration classification to the control and manipulation device 1 through the Bluetooth wireless communication (as indicated by double-headed arrow 4 of FIG. 1). When the Bluetooth phone base 20 receives an incoming call again, although at this time the Bluetooth communication device 24 is no longer located within the original coverage range 22, the Bluetooth phone base 20 still transmits the control message of search classification to the control and manipulation device 1 by means of Bluetooth wireless communication (as shown by double-headed arrow 2 in FIG. 1), which allows the Bluetooth phone base 20 to get aware that the Bluetooth communication device 24 is currently located in the coverage range 42 of the Bluetooth phone base 40. Consequently, the Bluetooth phone base 20 forwards the incoming call to the Bluetooth phone base 40 through PABX 3, and the Bluetooth communication device 24 is alerted through the Bluetooth phone base 40.

However, as shown in FIG. 1, since the Bluetooth wireless communication has inherent limitations, such as distance limitation and interference caused by obstacles, it frequently happens that only some of the Bluetooth phone bases can maintain direct contact with the control and manipulation device 1 for transmission of control messages. For example, in the embodiment illustrated in FIG. 1, only the Bluetooth phone bases 20 and 40 are allowed to send out the control messages to the control and manipulation device 1 and the other Bluetooth phone bases, such as phone bases 10, 30, 50, and 60, may not effectively communicate with the control and manipulation device 1. Under this circumstance, the Bluetooth communication device 24 cannot receive any incoming call if the communication device 24 is located in the coverage areas 12, 32, 52, and 62 of the phone bases 10, 30, 50, and 60, even if an attempt to forward the incoming call is done by PABX 3.

In view of the above-mentioned drawbacks and limitations of the prior art, the present invention is aimed to allow free roaming for Bluetooth communication devices among Bluetooth phone bases regardless any interference may be present between the phone bases and PABX.

### SUMMARY OF THE INVENTION

Therefore, an objective of the present invention is to provide a method for controlling and determining communication transmission route, whereby a Bluetooth communication device is allowed to roam among a group of Bluetooth phone bases without limitations. Also provided is a device for controlling and determining communication transmission route in which the method of the present invention can be embodied.

In order to achieve the above objective, the present invention provides a method for controlling and determining a communication transmission route of a Bluetooth communication device among a group of Bluetooth phone bases, wherein a control message is successively transmitted through a number of phone bases in order to establish a wireless link between any one of the phone bases and an exchange station for forwarding an incoming call to the one of the phone base. The present invention also provides a device for embodying the method, comprising a navigation map module and a route determination module. The navigation map module is used to receive the registration procedure carried out by the group of Bluetooth phone bases by means of Bluetooth wireless broadcast, and through this obtaining the information of relative position of the group of Bluetooth phone bases in the navigation network, so as to establish the navigation map. The route determination module is used to determine the transmission route based on the navigation map and through the route determination procedure, such that each Bluetooth phone base is able to transmit the control message to the control and manipulation device via other Bluetooth phone bases.

The spirit and advantages of the present invention can be understood more thoroughly through the following detailed description together with the attached drawings.

### BRIEF DESCRIPTION OF THE DRAWINGS

The related drawings in connection with the detailed description of the present invention to be made later are described briefly as follows, in which:

FIG. 1 is a schematic diagram of a communication network comprised of a group of Bluetooth phone bases according the prior art;

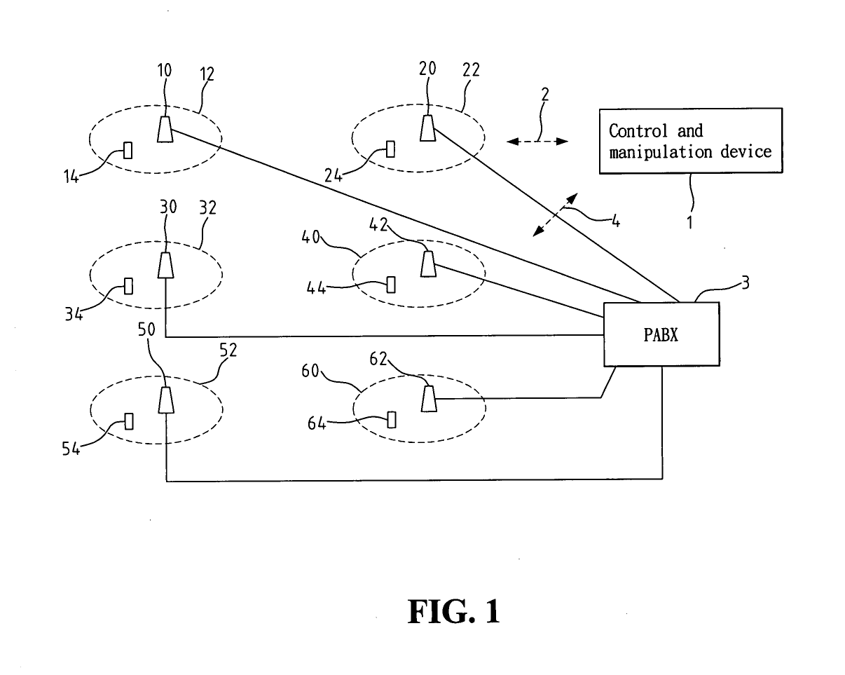

FIG. 2 is a schematic diagram of a communication network comprised of a group of Bluetooth phone bases according the present invention; and

FIG. 3 is a schematic diagram of a route control and manipulation device according to the present invention.

### DETAILED DESCRIPTION OF THE PREFERRED EMBODIMENT

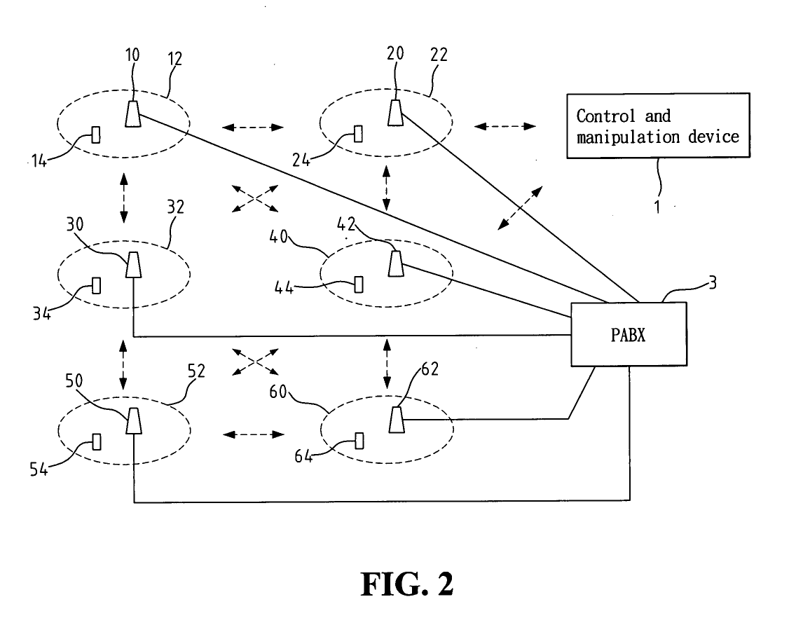

With reference to the drawings and in particular to FIG. 2, a Bluetooth phone communication network in which a method for controlling and determining a transmission route in accordance with the present invention may be embodied is shown. The network comprises an exchange station 3, such as a private automatic branch exchange (PABX), and a group of Bluetooth phone bases comprised of a plurality of individual Bluetooth phone bases 10, 20, 30, 40, 50, 60. Some of the phone bases, such as phone bases 20, 40, are so located as to be able to directly communicate with PABX 3, while the remaining phone bases 10, 30, 50, 60 somehow cannot perform direct communication with PABX 3. In accordance with the present invention, each of the phones bases 10, 30, 50, 60 can be linked in an indirect manner with PABX 3 to allow for transmission of a control message between the phone base 10, 30, 50, 60 and PABX 3. This is done by successively transmitting the control message from an originating phone base along a route comprised of selected ones of the phone bases 10-60 until the message is received by the destination phone base or PABX. The term “successively” means the message is transmitted from the originating phone base to an adjacent phone base and further transmitted to a further phone base and so on until the message is received by one of the phone bases that are in direct communication with PABX 3. For example, when an originating phone base, such as phone base 50, sends out a control message through Bluetooth wireless broadcasting, the control message is received by adjacent phone bases, which are phone bases 30, 60 in the embodiment illustrated, which in turn forward the control message by wireless broadcasting so that the control message is received by the phone bases of direct communication with PABX, which are phone bases 20, 40 in the embodiment illustrated. Eventually, the control message is applied to PABX 3 by the phone base 20 or 40. Thus, the control message is transmitted from the phone base 50 to PABX 3 through phone bases 30, 20 in succession.

As such, through Bluetooth phone base 50 is not able to transmit the control messages to the control and manipulation device 1 directly through Bluetooth transmission due to the various factors of distance or obstacles etc., it can however 0transmit the control message to the control and manipulation device successively through the above-mentioned method. In the following, we will discuss in detail the various components of the route control and manipulation device 1 of the present invention, and how these components work in cooperation with the above-mentioned system operation.

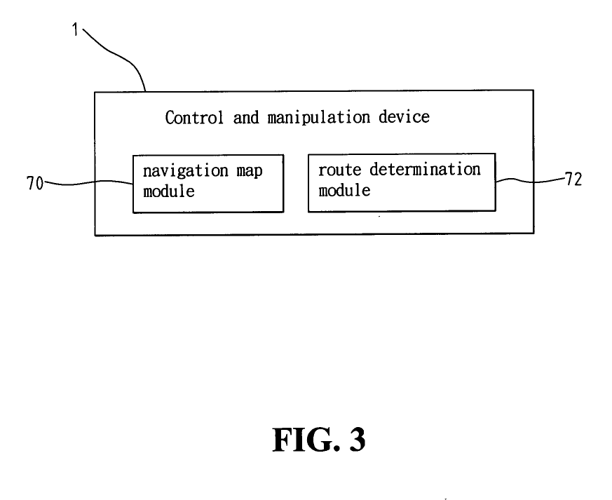

Also referring to FIG. 3, the route of successive transmission of the control message is determined by the route control and manipulation device in accordance with the present invention. The route control and manipulation device 1 comprises a navigation map module 70 and a route determination module 72. The navigation map module 70 receives registration information from all Bluetooth phone bases 10-60 of the communication network through Bluetooth wireless broadcasting, and based on such information, establishes a “map” regarding information of relative positions of the Bluetooth phone bases in the communication network. The route determination module 72 determine the transmission route based on the navigation map in accordance with a route determination procedure, which may be established in advance, so as to enable each Bluetooth phone base to transmit the control message to the control and manipulation device 1 along the transmission route comprised of selected ones of the Bluetooth phone bases 10-60 in an efficient way.

The registration of the Bluetooth phone bases in the navigation map module 70 means that, upon activated or reactivated, each Bluetooth phone base 10-60 carries out a registration procedure by sending out messages either directly or in succession through Bluetooth wireless broadcasting as mentioned above. The navigation map module 70 receives the messages and establishes the information of relative positions of the Bluetooth phone bases 10-60 in the communication network, which forms the navigation map. In other words, the control and manipulation device 1 can recognize that the Bluetooth phone bases 30,40, 60 are located adjacent to the Bluetooth phone base 50 through the navigation map.

Based on the navigation map, the route determination module 72 may determine a transmission route between for example the Bluetooth phone base 50 and the control and manipulation device 1 (or PABX 3) through the route determination procedure. The route determination procedure determines the transmission route based on three types: broadcasting, optimization, and manual definition.

A broadcasting type transmission route is determined as follows. First, the originating phone base, such as Bluetooth phone base 50 in the embodiment illustrated, sends out a control messages to the adjacent Bluetooth phone bases 30, 40, 60 by means of Bluetooth wireless broadcasting. The adjacent Bluetooth phone bases 30,40, 60 that receive the control message forward the control message to their adjacent Bluetooth phone bases by means of Bluetooth wireless broadcasting until the control message is received by the control and manipulation device 1. Apparently, the broadcasting transmission route is not fixed and can be varied from time to time for the broadcasting message from an upstream phone base can be received by different ones of the adjacent downstream phone base at different times and forwarded to different one of further downstream phone bases. Such a non-fixed nature of the broadcasting transmission route can easily induce “broadcasting storm” which is chaos of electromagnetic waves occupying the space among the phones bases 10-60, leading to serious degradation of overall operation efficiency of the communication system.

The optimum route determination procedure is proposed to eliminate the inefficiency caused by the broadcasting route determination. In the optimum route determination procedure, broadcasting type transmission routes are determined first and analysis is performed to obtain from the broadcasting transmission routes the optimum route that allows for the most efficient transmission of message from the originating phone base (such as phone base 50) to the control and manipulation device 1. Such an optimum route is recorded for future transmission of messages from the originating phone base, namely phone base 50, to the control and manipulation device 1. In the embodiment illustrated, the optimum transmission route is the one that extends from the originating phone base 50 to the adjacent phone base 40 that is also in direct communication with the control and manipulation device 1. In case the phone base 40 is down, the optimum route can be switched to the one that extends from the originating phone base 50 to for example phone base 30 and then phone base 20 that is in direct communication with the control and manipulation device 1.

The manual defined transmission route is a transmission route between the originating phone base (the phone base 50, for example) and the control and manipulation device 1 through phone bases selected manually or by an operator or a user. In the embodiment illustrated, the transmission route between the phone base 50 and the control and manipulation device 1 can extend through any of the remaining phone bases 10, 20, 30, 40, 60. For example, a manual defined transmission route between the phone base 50 and the control and manipulation device 1 may extend, in succession, through the phone base 30, the phone base 10, and The phone base 20 that is in direct communication with the control and manipulation device 1.

To sum up, the present invention provides a control and manipulation device 1 and a method used for route determination, which allows each Bluetooth phone base within a communication network to establish link with a control and manipulation device 1 by successfully transmitting a control message through selected phone bases that are linked in succession between the originating phone base and the control and manipulation device 1, whereby a Bluetooth communication device is able to roam among the coverage areas of different phone bases in the communication network without limitations.

By way of the above detailed description of the preferred embodiment, it is intended to illustrate more clearly the characteristic and spirit of the present invention rather than to be restrictive to the scope of the present invention with the preferred embodiment disclosed above. On the contrary, its purpose is to include the various changes and the equivalent arrangements, which fall in the scope of the appended claims.

What is claimed is:

1. A device for determining a transmission route between an originating phone base that is among a group of Bluetooth phone bases within a communication network and an exchange station, which transmission route allows for transmission of a control message from the originating phone base to the exchange station through selected ones of the phone bases in succession, whereby a Bluetooth communication device located in a coverage area of each phone base of the group is allowed to receive an incoming call from the exchange station via the transmission route, the device comprising:
a navigation map module, which receives registration procedure carried out by the group of Bluetooth phone bases through Bluetooth wireless broadcasting, and obtains information of relative position of each Bluetooth phone base in the communication network, so as to establish a navigation map; and
a route determination module, which determines the transmission route based on the navigation map in accordance with a route determination procedure, such that the control message is transmitted from the respective Bluetooth phone base to the device via the selected ones of the Bluetooth phone bases.

2. The device as claimed in claim 1, wherein the route determination procedure comprises the following steps:
(a) the originating phone base transmitting the control message to an adjacent phone base through Bluetooth wireless broadcasting and
(b) upon receiving the control message, the adjacent phone base transmitting the control message to an adjacent phone base until the control message is received by the device.

3. The device as claimed in claim 1, wherein the route determination procedure comprises the following steps:
(a) the originating phone base transmitting the control message to an adjacent phone base through Bluetooth wireless broadcasting;
(b) upon receiving the control message, the adjacent phone base transmitting the control message to an adjacent phone base until the control message is received by the device; and
(c) analyzing and obtaining an optimum transmission route that is used to transmit the control message to the device.

4. The device as claimed in claim 1, wherein the route determination procedure comprises the following step:
(a) selecting among the group the phone bases through which the control message are transmitted from the originating phone base to the device so as to define the transmission route.

5. A route control method, which is used to determine a transmission route among a group of Bluetooth phone bases for transmitting a control message from an originating phone base through selected ones of the phone bases in succession so as to establish a communication network, whereby a Bluetooth communication device located in a coverage area of each phone base of the group is allowed to receive an incoming call from the exchange station via the transmission route, the method comprising the following steps:
(1) receiving a registration procedure carried out by the group of Bluetooth phone bases through Bluetooth wireless broadcasting;
(2) obtaining information regarding relative position of each phone base in the communication network, so as to establish the navigation map;
(3) basing on the navigation map to determine the transmission route through a route determination procedure, so as to enable each phone base to transmit the control message to a control device.

6. The method as claimed in claim 5, wherein the route determination procedure it comprises the following steps:
(a) the originating phone base transmitting the control message to an adjacent phone base through Bluetooth wireless broadcasting; and
(b) upon receiving the control message, the adjacent phone base transmitting the control message to an adjacent Bluetooth phone base until the control message is received by the control device.

7. The method as claimed in claim 5, wherein the route determination procedure comprises the following steps:
(a) the originating phone base transmitting the control message to an adjacent phone base through Bluetooth wireless broadcasting;
(b) upon receiving the control message, the adjacent phone base transmitting the control message to an adjacent Bluetooth phone base until the control message is received by the control device; and
(c) analyzing and obtaining an optimum transmission route that is used to transmit the control message to the control device.

8. The method as claimed in claim 5, wherein the route determination procedure comprises the following step:
(a) selecting among the group the phone bases through which the control message are transmitted from the originating phone base to the device so as to define the transmission route.
